(19) United States
(12) Patent Application Publication
(10) Pub. No.: US 2009/0035436 A1
(43) Pub. Date: Feb. 5, 2009

(54) Sugar-Free Dessert Products

(76) Inventors: Richard Leshik, Brookfield, CT (US); Elliot Merkle, New Fairfield, CT (US)

Correspondence Address: FITCH EVEN TABIN & FLANNERY, 120 S. LASALLE STREET, SUITE 1600, CHICAGO, IL, 60603-3406, US

(21) Appl. No.: 12/245,332

(22) Filed: Oct. 3, 2008

Related U.S. Application Data
(63) Continuation of application No. 11/069,087, filed on Feb. 28, 2005.

(51) Int. Cl. A23L 1/307; A23L 1/187

(52) U.S. Cl. 426/548

(57) ABSTRACT

This invention provides sugar-free dessert-type food products (e.g., sugar-free puddings) containing an artificial sweetener composition comprising an artificial sweetener selected from the group consisting of sucralose and a mixture of sucralose and acesulfame potassium and a sugar alcohol . It has been found that the aftertaste (sometimes described as bitterness) experienced by a certain population with sugar-free dessert-type products containing artificial sweeteners can be significantly reduced, and in some cases eliminated, by using reduced levels of artificial sweeteners in combination with sugar alcohols.

### FIELD OF THE INVENTION

This invention provides sugar-free dessert-type food products (e.g., sugar-free puddings) containing an artificial sweetener composition having significantly reduced aftertaste. It has been found that the undesirable aftertaste experienced—often described as bitterness—by a certain population with sugar-free dessert-type products containing artificial sweeteners can be significantly reduced, and in some cases eliminated, by using reduced levels of artificial sweeteners in combination with sugar alcohols.

### BACKGROUND

Sugar-free dessert products sweetened with artificial sweeteners, such as sucralose, acesulfame potassium, and mixtures thereof, have become extremely popular. The increasing calorie consciousness of Americans has sparked a growing consumer demand for low-calorie food products, including low-calorie dessert products. The number of people who consume such low-calorie products has more than doubled during the past decade as the availability of such artificial sweeteners has dramatically expanded the low-calorie food market. Indeed, recent estimates indicate that more than 180 million adult Americans are incorporating low-calorie, sugar-free foods in their diet as part of a healthy lifestyle.

Unfortunately, simple replacement of natural sugar with such artificial sweeteners—especially sucralose, acesulfame potassium—results in an undesirable aftertaste for a significant segment (estimated at about 40 percent or more) of the population. In many cases, the aftertaste is sufficiently strong that many individuals cannot use, refuse to use, or simply avoid using food products—especially dessert-type products where higher levels of sweetness are desired—containing these artificial sweeteners in spite of their desire to avoid natural sugar and its high calorie content.

Sucralose and acesulfame potassium are two popular nonnutritive sweeteners. Sucralose (1,6-dichloro-1,6-dideoxy-β-D-fructofuranosyl-4-chloro-4-deoxy-α-D-galactopyranoside; also known as trichlorogalactosucrose or 4,1′,6′-trichlorogalactosucrose) is a disaccharide made from sucrose in a five-step process that selectively substitutes three atoms of chlorine for three hydroxyl groups in the sugar molecule. It is a free-flowing, white crystalline solid that is soluble in water with a sweetness intensity that is about 600 times that of sucrose (i.e., a sugar equivalent sweetness of about 600). In 1998, sucralose was approved by the United States Food and Drug Administration (FDA) for use in 15 food and beverage categories; approval as a general-purpose sweetener in all foods, beverages, dietary supplements, and medical foods was given in 1998. Acesulfame potassium or acesulfame K is a white, odorless, free flowing crystalline powder which is about 200 times sweeter than sucrose (i.e., a sugar equivalent sweetness of about 200); it was approved as a tabletop sweetener by the FDA in 1988. Sucrose, by definition, has a sugar equivalent sweetness of 1.

Although sucralose is generally reported not to have an unacceptable aftertaste like certain other artificial sweeteners, we have found that prepared food products, especially desserts, containing greater than about 8 percent sugar equivalent sweetness using sucralose are difficult to prepare without an unacceptable aftertaste. Combining sucralose with acesulfame potassium at such high sugar equivalent sweetness levels does not appear to significantly alleviate this aftertaste problem. Since dessert products generally contain more than about 9 percent sugar equivalent sweetness (typically in the range of about 9 to 20 percent sugar equivalent sweetness), the sucralose aftertaste can be especially noticeable.

It would be desirable, therefore, to provide sugar-free dessert products containing artificial sweetener compositions having reduced aftertaste, and preferably essentially no aftertaste, especially for that segment of population which finds that sucralose and/or sucralose and acesulfame potassium mixtures exhibit such an unacceptable aftertaste that they avoid products containing such sweeteners. Dessert products having essentially no aftertaste or reduced-aftertaste would allow more individuals to take advantage of such low-calorie alternatives. The present invention provides such sugar-free dessert products, including, but not limited to, mousses, puddings, gelatins, gel-type desserts, and the like containing artificial sweetener compositions.

### SUMMARY OF THE INVENTION

The aftertaste experienced by a certain population with sugar-free dessert products containing artificial sweeteners can be substantially avoided, and in some cases eliminated, without loss of sweetness, by effectively reducing the level of the artificial sweeteners and adding sugar alcohols. For this population, the reduction in the amount of artificial sweeteners and the addition of the sugar alcohol will provide an acceptable (i.e., sufficiently sweet without significant aftertaste) sugar-free dessert product so that this population can enjoy the benefits of such sugar-free dessert products. For purposes of this invention, a “sugar-free dessert product” is intended to mean a dessert product containing 0 to about 0.5 g total sugar per single serving. Such sugar-free dessert products could, therefore, be labeled as “sugar free” under the current FDA standard (i.e., less than 0.5 g total sugar (i.e., total mono- and di-saccharides) per single serving; see 21 CFR part 101.60 (c)(l (2004)). Total sugar includes all sugar present in the dessert product regardless of whether added as sugar (i.e., as separate ingredient) or included in one or more of the other ingredients. Thus, to meet these limitations, it may be necessary to use components having reduced levels of sugar (e.g., reduced levels of sucrose, lactose, or other sugars).

The present invention uses an artificial sweetener composition comprising an artificial sweetener and a sugar alcohol. In a preferred embodiment, the artificial sweetener composition comprises (1) an artificial sweetener selected from the group consisting of sucralose and a mixture of sucralose and acesulfame potassium and (2) a sugar alcohol selected from the group consisting of sorbitol (sugar equivalent sweetness of about 0.6), lactitol (sugar equivalent sweetness of about 0.4), xylitol (sugar equivalent sweetness of about 1), mannitol (sugar equivalent sweetness of about 0.5), maltitol (sugar equivalent sweetness of about 0.9), erythritol (sugar equivalent sweetness of about 0.7), isomalt (sugar equivalent sweetness of about 0.55), and hydrogenated starch hydrolysates (HSH; sugar equivalent sweetness of about 0.4 to about 0.9), as well as mixtures thereof. Preferably, the artificial sweetener is a mixture of sucralose and acesulfame potassium and the sugar alcohol is xylitol, maltitol, erythritol, and mixtures thereof. Even more preferably, the artificial sweetener is a mixture of sucralose and acesulfame potassium (generally in a sugar equivalent sweetness ratio of sucralose to acesulfame potassium of more than about 75:25, preferably about 99:1 to about 75:25, and more preferably about 90:10, which approximately corresponds to a weight ratio of sucralose to acesulfame potassium of more than about 50:50, preferably about 97:3 to about 50:50, and more preferably about 75:25) and the sugar alcohol is xylitol.

Generally, the artificial sweetener composition contains a sufficient amount of the artificial sweetener to provide about 20 to about 90 percent of the total sugar equivalent sweetness and a sufficient amount of the sugar alcohol to provide about 10 to about 80 percent of the total sugar equivalent sweetness. Preferably, the artificial sweetener composition contains a sufficient amount of the artificial sweetener to provide about 39 to about 67 percent of the total sugar equivalent sweetness and a sufficient amount of the sugar alcohol to provide about 33 to about 61 percent of the total sugar equivalent sweetness; even more preferably, the artificial sweetener composition contains a sufficient amount of the artificial sweetener to provide about 40 to about 55 percent of the total sugar equivalent sweetness and a sufficient amount of the sugar alcohol to provide about 45 to about 60 percent of the total sugar equivalent sweetness. To provide the desired balance of sweetness without undesirable aftertaste in prepared food products, the composition of the artificial sweetener composition and the amount included in the sugar-free dessert product preferably is effective to provide about 0.005 to about 0.025 weight percent of sucralose and about 2 to about 12 weight percent of xylitol as the sugar alcohol (or other sugar alcohols on a sugar equivalent basis), based on the total weight of the prepared sugar-free dessert product; if acesulfame potassium is included in the artificial sweetener composition, it preferably is present at less than about 50 weight percent of the level of sucralose.

The artificial sweetener composition used in the present invention can be prepared as a preblended composition by combining the components (by, for example, simply mixing, co-drying, or the like) or the composition may be prepared in situ by adding the necessary amounts of the components to a desired dessert product.

The present artificial sweetener composition is for use in sugar-free desserts including, for example but not limited to, mousses, puddings, gelatins, gel-type desserts, and the like. It is especially suited for use in sugar-free puddings, especially in puddings containing a calcium-sensitive, thermally-irreversible gelling hydrocolloid (e.g., sodium alginate). U.S. Pat. No. 5,238,699 (Aug. 24, 1993), which is hereby incorporated by reference, provides no- or low-fat, ready-to-eat sugar-free puddings using a calcium-sensitive, thermally-irreversible gelling hydrocolloid.

In a preferred embodiment, the present invention also provides packaged, high temperature-processed, ready-to-eat pudding, wherein the high temperature is about 265° F. or higher, prepared from a formulation comprising a fat content of less than about 3 weight percent, water, a source of soluble calcium, thickening agent, a effective amount of an artificial sweetener composition, an emulsifier/stabilizer and/or polyphosphate, and about 0.01 to about 1.5 weight percent of an ungelled, calcium-sensitive, thermally-irreversible, gelling hydrocolloid selected from the group consisting of algin and salts thereof, low methoxyl pectin, gellan gum, and combinations thereof; wherein the artificial sweetener composition comprises (1) an artificial sweetener selected from the group consisting of sucralose and a mixture of sucralose and acesulfame potassium and (2) a sugar alcohol selected from the group consisting of sorbitol, lactitol, xylitol, mannitol, maltitol, erythritol, isomalt, hydrogenated starch hydrolysates, and mixtures thereof.

In another preferred embodiment, the present invention also provides a method for producing a packaged, ready-to-eat pudding, said method comprising the steps of: (1) combining and mixing water, a source of soluble calcium, starch, an artificial sweetener composition, an emulsifier/stabilizer and/or polyphosphate, and an ungelled, calcium-sensitive, thermally-irreversible, gelling hydrocolloid at a level of about 0.01 to about 1.5 weight percent, the hydrocolloid being added to an aqueous solution containing soluble calcium at a temperature of less than about 150° F. and the hydrocolloid being selected from the group consisting of algin and salts thereof, low methoxyl pectin, gellan gum, and combinations thereof; (2) homogenizing the mix; (3) heating the mixture to a temperature above about 265° F. for a sufficient period of time to sterilize the mix and cook the starch; (4) cooling the sterilized mix to a temperature below about 140° F.; and (5) packaging the cooled pudding; wherein the artificial sweetener composition comprises (1) an artificial sweetener selected from the group consisting of sucralose and a mixture of sucralose and acesulfame potassium and (2) a sugar alcohol selected from the group consisting of sorbitol, lactitol, xylitol, mannitol, maltitol, erythritol, isomalt, hydrogenated starch hydrolysates, and mixtures thereof.

### DETAILED DESCRIPTION

The present invention provide sugar-free dessert products using an artificial sweetener composition comprising an artificial sweetener and a sugar alcohol. In a preferred embodiment, the artificial sweetener composition comprises a heat and neutral pH stable artificial sweetener and a sugar alcohol. Preferably, the artificial sweetener is selected from the group consisting of sucralose and a mixture of sucralose and acesulfame potassium and the sugar alcohol is selected from the group consisting of sorbitol, lactitol, xylitol, mannitol, maltitol, erythritol, isomalt, hydrogenated starch hydrolysates, and mixtures thereof, wherein the relative amounts of the artificial sweetener and the sugar alcohol are balanced to significantly reduce aftertaste normally associated with the artificial sweetener. For purposes of this invention, “significantly reduce the aftertaste” is intended to mean at least a 25 percent reduction in taste test panelists reporting undesirable aftertaste. Preferably, the artificial sweetener is sucralose or a mixture of sucralose and acesulfame potassium and the sugar alcohol is xylitol. Even more preferably, the artificial sweetener is a mixture of sucralose and acesulfame potassium (generally in a sugar equivalent sweetness ratio of sucralose to acesulfame potassium of more than about 75:25, preferably about 97:5 to about 75:25, and more preferably about 90:10) and the sugar alcohol is xylitol. Generally, the artificial sweetener composition contains a sufficient amount of the artificial sweetener to provide about 20 to about 90 percent of the total sugar equivalent sweetness and a sufficient amount of the sugar alcohol to provide about 10 to about 80 percent of the total sugar equivalent sweetness. Preferably, the artificial sweetener composition contains a sufficient amount of the artificial sweetener to provide about 39 to about 67 percent of the total sugar equivalent sweetness and a sufficient amount of the sugar alcohol to provide about 33 to about 61 percent of the total sugar equivalent sweetness; even more preferably, the artificial sweetener composition contains a sufficient amount of the artificial sweetener to provide about 40 to about 55 percent of the total sugar equivalent sweetness and a sufficient amount of the sugar alcohol to provide about 45 to about 60 percent of the total sugar equivalent sweetness. To provide the desired balance of sweetness without the undesirable aftertaste in prepared dessert products, the composition of artificial sweetener composition and the amount added preferably is effective to provide about 0.005 to about 0.025 weight percent of sucralose and about 2 to about 12 weight percent of xylitol (or other sugar alcohol on a equivalent sweetness basis), based on the total weight of the prepared dessert product; if acesulfame potassium is included in the artificial sweetener, it preferably is present less than about 50 weight percent of the level of sucralose.

The present artificial sweetener composition is ideally suited for use in sugar-free puddings, especially in puddings containing a calcium-sensitive, thermally-irreversible gelling hydrocolloid (e.g., sodium alginate). U.S. Pat. No. 5,238,699 (Aug. 24, 1993), which is hereby incorporated by reference, provides no- or low-fat, ready-to-eat sugar-free puddings using a calcium-sensitive, thermally-irreversible gelling hydrocolloid. The sugar-free puddings of this invention may include no-fat, low-fat, and full-fat puddings; they may also include ready-to-eat puddings as well as puddings prepared from mixes, preferably dry mixes, by the consumer just prior to consumption. Generally, no-fat or low-fat (i.e., less than about 3 weight percent fat), ready-to-eat puddings are preferred.

In a preferred embodiment, the present invention provides packaged, high temperature-processed, ready-to-eat pudding, wherein the high temperature is about 265° F. or higher, prepared from a formulation comprising a fat content of less than about 3 weight percent, water, a source of soluble calcium, a thickening agent, a effective amount of an artificial sweetener composition, an emulsifier/stabilizer, and about 0.01 to about 1.5 weight percent of an ungelled, calcium-sensitive, thermally-irreversible, gelling hydrocolloid selected from the group-consisting of algin and salts thereof, low methoxyl pectin, gellan gum, and combinations thereof; wherein the artificial sweetener composition comprises (1) an artificial sweetener selected from the group consisting of sucralose and a mixture of sucralose and acesulfame potassium and (2) a sugar alcohol selected from the group consisting of sorbitol, lactitol, xylitol, mannitol, maltitol, erythritol, isomalt, hydrogenated starch hydrolysates, and mixtures thereof; wherein the relative amounts of the artificial sweetener and the sugar alcohol are balanced to significantly reduce aftertaste in the pudding as compared to a similar pudding prepared only with the artificial sweetener.

In another preferred embodiment, the present invention also provides a method for producing a packaged, ready-to-eat pudding having a fat level of 0 to about 3 weight percent, said method comprising the steps of: (1) combining and mixing water, a source of soluble calcium, starch, an artificial sweetener composition, an emulsifier/stabilizer and/or polyphosphate, and an ungelled, calcium-sensitive, thermally-irreversible, gelling hydrocolloid at a level of about 0.01 to about 1.5 weight percent, the hydrocolloid being added to an aqueous solution containing soluble calcium at a temperature of less than about 150° F. and the hydrocolloid being selected from the group consisting of algin and salts thereof, low methoxyl pectin, gellan gum, and combinations thereof; (2) homogenizing the mix; (3) heating the mixture to a temperature above about 265° F. for a sufficient period of time to sterilize the mix and cook the starch; (4) cooling the sterilized mix to a temperature below about 140° F.; and (5) packaging the cooled pudding; wherein the artificial sweetener composition comprises (I) an artificial sweetener selected from the group consisting of sucralose and a mixture of sucralose and acesulfame potassium and (ii) a sugar alcohol selected from the group consisting of sorbitol, lactitol, xylitol, mannitol, maltitol, erythritol, isomalt, hydrogenated starch hydrolysates, and mixtures thereof and wherein the relative amounts of the artificial sweetener and the sugar alcohol are balanced to significantly reduce aftertaste in the pudding as compared to a similar-pudding prepared only with the artificial sweetener.

Although the artificial sweetener composition of this invention can be used in a wide variety of dessert products, it is especially adapted for use in ready-to-eat, low or no-fat puddings containing a calcium-sensitive, thermally-irreversible gelling hydrocolloid (e.g., sodium alginate) as described in U.S. Pat. No. 5,238,699 (Aug. 24, 1993). The use of such artificial sweetener compositions now will be described in detail with reference to such puddings. An ultra-high temperature (above 265° F.) processed, and packaged pudding formulation having a fat content of from 0 to 3 weight percent is prepared using a combination of conventional ready-to-eat pudding ingredients, such as water, lactose-reduced milk solids (e.g., milk protein concentrate) and/or another source of soluble calcium, starch (i.e., uncooked starch) and/or other thickening agents, an artificial sweetener composition, emulsifier, flavor and color, in combination with from about 0.01 to about 1.5 weight percent of a calcium-sensitive, irreversible, gelling hydrocolloid, such as sodium alginate, by weight of the pudding. The preferred hydrocolloid is a high molecular weight sodium alginate (e.g., about 120,000 to about 190,000 M.W.), at a level of from about 0.01 to about 0.5 weight percent, preferably about 0.08 to about 0.3 weight percent. High molecular weight alginates are preferred since a lower usage level is possible compared to lower molecular weight alginates.

According to one method for preparing the pudding product of this invention, the liquid or reconstituted ingredients, such as water and reduced- sugar milk or milk protein concentrate (e.g., whole, low-fat or skim milk or derived therefrom), are mixed and heated to a temperature between about 90 and about 130° F. Any fatty ingredients (e.g., fats, emulsifiers and/or stabilizers) may then be added to the heated liquid components. The dry ingredients, including the calcium-sensitive gelling hydrocolloid and the artificial sweetener composition (either in the form of a preblended composition or the individual components), are then added to the liquid mix using a relatively high level of agitation. An induction mixer is one type of device for providing the desired agitation. Any volatile flavor component should be added last in order to minimize volatilization exposure to heat. The mixture is thoroughly mixed, such as in a homogenizer, cooked at a temperature above 265° F., preferably about 275 to about 300° F., and then cooled. Cooking may be effected using either direct or indirect heat with a scraped-surface heat exchanger being typical for indirect heating and steam injection being a typical procedure for applying direct heat. The cooling step should be done while the mix is being subjected to shear conditions. Cooling may be accomplished using plate, tubular, and/or scraped-surface heat exchangers. The cooled pudding formulation is then packaged at a temperature below 140° F., preferably below about 110° F. and typically at about 75° F. The formulations of this invention processed in this manner produce a packaged sugar-free, low/no fat pudding which has the smooth texture and the weak, soft gel structure of full-fat, ready-to-eat puddings.

These puddings will typically have a composition in accordance with the following formula which represents an unflavored and uncolored pudding mix using an artificial sweetener composition containing xylitol as the sugar alcohol.

| | Broad Range | Preferred Range |
|---|---|---|
| | (wt. %) | (wt. %) |
| Water | 60-85 | 68-80 |
| Sucralose | 0.005-0.025 | 0.009-0.015 |
| Acesulfame Potassium | 0-0.0125 | 0.003-0.005 |
| Xylitol | 2-12 | 5-9 |
| Uncooked Starch | 2-9 | 3.5-7 |
| Sugar-Reduced or Sugar | 0.2*-6 | 1-4 |
| Free Milk Solids | | |
| Fat | 0-3 | 0.5-1.5 |
| Emulsifier/Stabilizer | 0.05-0.5 | 0.08-0.4 |
| Calcium-Sensitive Gelling | 0.01-1.5 | 0.08-0.9 |
| Hydrocolloid | | |

*If an alternate calcium source is provided, the amount of sugar-reduced or sugar free milk solids could be reduced to zero.

Flavor and color agents and other functional ingredients are preferably included in the pudding formulation (generally at levels less than about 3 weight percent) so as to produce the desired end product, such as vanilla, chocolate, or butterscotch pudding. The use of a food-grade alkali to adjust the pH of the pudding to a range of about 6.5 to about 7.0 may be desirable. If desired, the pudding formulation could be completely free of all sugars by using lactose-free milk solids or by eliminating milk solids altogether and substituting an alternate source of soluble calcium, such as calcium lactate or calcium biphosphate.

The pudding composition of the present invention preferably may also contain an emulsifier/stabilizer component which aids in dispersing and mixing of dry ingredients and contributes to the desired firm, smooth texture. A preferred emulsifier/stabilizer is sodium stearoyl-2-lactylate. Other suitable emulsifier/stabilizer ingredients include, for example, mixtures of mono- and diglycerides prepared by direct esterification of edible fatty acids and glycerine.

The term emulsifier/stabilizer is meant to indicate that the ingredient serves as both an emulsifier and a stabilizer. In the case of fat-free puddings, the emulsifier functionality is not needed and the ingredient functions solely as a stabilizer. In the case of fat-containing puddings, the ingredient provide both emulsifier and stabilizer functionalities.

The term fat-free, as used in this invention, is meant to include the presence of a low amount of a fatty emulsifier/stabilizer material or fat from other sources so long as the pudding contains less than 0.5 grams of fat per serving. It is also within the scope of this invention that, in accordance with commonly assigned U.S. Pat. No. 5,221,549 (Jun. 22, 1993), that the stabilizer ingredient can be totally or partially replaced by a low level (up to about 0.5 weight percent) of polyphosphates, preferably pyrophosphates. Thus, for purposes of this invention, the emulsifier/stabilizer is intended to include such polyphosphates.

Preferably, the starch component of the pudding formulation consists of a combination of higher and lower modified, uncooked starches typically at a weight ratio of 1:1 to 9:1. The higher modified starch is typically a cross-linked, substituted starch, such as tapioca, waxy maize, or corn starch. The lower modified (e.g., unmodified) starch will typically be a tapioca, waxy maize or corn starch.

For producing the packaged, ready-to-eat puddings of this invention, the various ingredients of the composition are initially admixed, such as in the manner described above. The mixture is then mixed to effect thorough and complete dispersion, such as by homogenization. Typically, the mixture is heated to a temperature of up to about 130° F. and then passed through a mixing apparatus (e.g., a Manton-Gaulin™ homogenizer or a Bran-Lubbe™ homogenizer) in either a single or multiple-stage at an appropriate pressure. Since the preparation of home-made puddings has no true counterpart to a homogenization step, the products made according to the present invention can often be characterized as having textural and organoleptic properties even more preferred than the home-made “standard”.

The ultra-high temperature processing of the pudding composition typically will be conducted in scraped-surface heat exchange apparatus so as to best accommodate the increasing viscosity of the mixture during heating. Typically, the composition will be heated to a temperature of about 140° F. prior to being passed to ultra-high temperature processing. In the ultra-high temperature processing step, the composition will typically be heated to a temperature range of from about 275 to about 300° F. and then introduced into a suitable holding tube, to be held there at such temperature for the necessary time required to effect cooking and microbial kill. Thereafter, the cooked composition is cooled to a temperature suitable for filling into containers which are then sealed. Where the product container is a plastic material to be sealed with an adhesively-applied foil lid, cooling to a product temperature of below about 130° F., and preferably below about 110° F.

In commercial operation it may be desirable to provide a hold tank between the homogenization step and the cooking step in order to serve as a buffer against process disruptions. If such a tank is present, the tank should keep the pudding temperature at about 40° F. to retard microbiological growth.

If an aseptic-packaging process is to be implemented, the process will further include steps of sterilizing the containers and lids into which the sterilized pudding is packaged and then filling the container with pudding in a sterile environment. Such known methods as superheated steam, hydrogen peroxide, ultraviolet light, high-intensity light, and the like, are useful for sterilizing the packaging materials which, in the case of pudding, are typically composed of single-service, cup-shaped, plastic containers and flexible lid stock. The lid stock, may be foil-laminated polyester with a heat-sealable coating which will be heat sealed onto the container. The plastic container may be a thermoformed or molded container fabricated from a material such as high-impact polystyrene. These steps would also be desirable to reduce microbial activity even in the event that a true aseptic process in not being sought, such as when the pudding is placed in a refrigerated distribution system and sterility is not required but extended storage life is desirable.

This invention is further described but not limited by the following examples. All patents and publications referenced herein are hereby incorporated by reference.

### EXAMPLE 1

This example illustrates the use of the artificial sweetener composition in preparing sugar-free chocolate puddings. Puddings were prepared essentially as described in U.S. Pat. No. 5,238,699.

Test results for puddings prepared with sucralose/acesulfame potassium alone (control) and with maltitol (formulations in Table 1) are included in Table 3. Sample 1 (lowest level of sucralose in combination with maltitol) was the best overall. Test results for puddings prepared with sucralose/acesulfame potassium in combination with either maltitol or xylitol (formulations in Table 2) are included in Table 4. In each sample, the ratio of sucralose to acesulfame potassium was at about 90:10 based on sugar equivalent sweetness (about 75:25 based on weight). Table 1 provides the formulations for Samples 1 and 2 (control) listed in Table 3:

TABLE 1

Amount (wt. %)

| Ingredients | Sample 1 | Sample 2 (control) |
|---|---|---|
| Water | 88.0 | 90.0 |
| Milk Protein Concentrate | 1.5 | 1.5 |
| Maltitol | 2.0 | 0 |
| Sucralose | 0.023 | 0.026 |
| Acesulfame K | 0.0076 | 0.0085 |
| Coconut Palm Kernel Oil | 1.4 | 1.4 |
| Medium Dutched Cocoa | 1.7 | 1.7 |
| Modified Waxy Maize Starch | 4.6 | 4.6 |
| Salt | 0.3 | 0.3 |
| Sodium Stearoyl Lactylate | 0.2 | 0.2 |
| Sodium Alginate | 0.2 | 0.2 |
| Vanilla Flavor | 0.06 | 0.06 |

The other samples in Table 3 had similar formulations as in Table 1 except for the amounts of fat, artificial sweeteners, and sugar alcohols (amounts give in Table 3 below).

Table 2 provides the formulations for Samples 7, 11, 12, 15, 16, and 19 listed in Table 3.

TABLE 2

| | Amount (wt. %) | | | | | |
|---|---|---|---|---|---|---|
| Ingredients | Sample 7 | Sample 11 | Sample 12 | Sample 15 | Sample 16 | Sample 19 |
| Water | 83.2 | 88.1 | 83.2 | 86.9 | 82.9 | 86.6 |
| Milk Protein Concentrate | 1.8 | 1.5 | 1.8 | 1.8 | 1.8 | 1.8 |
| Maltitol | 0 | 2.0 | 0 | 3.0 | 0 | 3.0 |
| Xylitol | 7.0 | 0 | 7.0 | 0 | 7.0 | 0 |
| Sucralose | 0.0144 | 0.0228 | 0.0090 | 0.0164 | 0.0144 | 0.0218 |
| Acesulfame K | 0.0048 | 0.0076 | 0.0030 | 0.0055 | 0.0048 | 0.0073 |
| Coconut Palm Kernel Oil | 0.9 | 0.9 | 0.9 | 0.9 | 0.9 | 0.9 |
| Medium Dutched Cocoa | 1.7 | 1.7 | 1.7 | 1.7 | 2.3 | 2.3 |
| Modified Waxy Maize | 4.7 | 5.0 | 4.7 | 5.0 | 4.4 | 4.6 |
| Starch | | | | | | |
| Salt | 0.3 | 0.3 | 0.3 | 0.3 | 0.3 | 0.3 |
| Sodium Stearoyl Lactylate | 0.2 | 0.2 | 0.2 | 0.2 | 0.2 | 0.2 |
| Sodium Alginate | 0.18 | 0.18 | 0.18 | 0.18 | 0.18 | 0.18 |
| Whitener | 0.02 | 0.02 | 0.02 | 0.02 | 0.02 | 0.02 |
| Vanilla Flavor | 0.07 | 0.07 | 0.07 | 0.07 | 0.07 | 0.07 |

The other samples in Table 4 had similar formulations as in Table 2 except for the amounts of artificial sweeteners and sugar alcohols (amounts give in Table 4 below).

The best results were obtained using sucralose/acesulfame potassium in combination with xylitol. Generally as the sugar alcohol content increased, product acceptance increased. Increased levels of sugar alcohols allowed lower levels of sucralose/acesulfame potassium which apparently resulted in increased product acceptance. Xylitol outperformed maltitol at equivalent sugar alcohol levels and equivalent sweetness. Xylitol at 3 weight percent was comparable to maltitol at 7 weight percent monadic scores but better with lower unpleasant aftertaste levels. This is surprising in that the 3 weight percent xylitol samples had higher sucralose/acesulfame potassium levels then the 7 weight percent maltitol samples, indicating some additional synergetic effect.

TABLE 3

| | | | | Sugar | Sucralose (wt. %)/ | | | Sweetness | Tasters w/ |
|---|---|---|---|---|---|---|---|---|---|
| | Maltitol | Fat | Cocoa | Equivalent | Acesulfame | Overall Liking | Flavor Liking | Liking | Unpleasant |
| Sample | (wt. %) | (wt. %) | (wt. %) | Sweetness | Potassium (wt. %) | Monadic Score | Monadic Score | Monadic Score | Aftertaste (%) |
| 1 | 2 | 1.4 | 1.7 | 17 | 0.0228/0.0076 | 7.05 | 6.8 | 6.46 | 14.5 |
| 2 (control) | 0 | 1.4 | 1.7 | 17 | 0.0255/0.0085 | 6.70 | 6.53 | 6.19 | 27.4 |
| 3 | 2 | .7 | 1.7 | 19 | 0.0258/0.0086 | 7.16 | 7.02 | 6.48 | 27.9 |
| 4 (control) | 0 | .7 | 1.7 | 19 | 0.0285/0.0086 | 6.89 | 6.63 | 6.07 | 32.3 |
| 5 | 2 | 1.4 | 1.7 | 21 | 0.0288/0.0096 | 7.03 | 7.08 | 6.87 | 25.6 |
| 6 (control) | 0 | 1.4 | 1.7 | 21 | 0.0315/0.1050 | 6.53 | 6.37 | 5.99 | 32.4 |

TABLE 4

| | | | | Sugar | Sucralose (wt. %)/ | | | Sweetness | Tasters w/ |
|---|---|---|---|---|---|---|---|---|---|
| | Xylitol | Maltitol | Cocoa | Equivalent | Acesulfame | Overall Liking | Flavor Liking | Liking | Unpleasant |
| Sample | (wt. %) | (wt. %) | (wt. %) | Sweetness | Potassium (wt. %) | Monadic Score | Monadic Score | Monadic Score | Aftertaste (%) |
| 7 | 7 | 0 | 1.7 | 16.6 | 0.0144/0.0048 | 7.2 | 7.0 | 6.7 | 18.1 |
| 8 | 0 | 7 | 1.7 | 16.6 | 0.0176/0.0059 | 7.2 | 6.9 | 6.8 | 23.8 |
| 9 | 3 | 0 | 1.7 | 16.6 | 0.0204/0.0080 | 7.1 | 6.9 | 6.6 | 16.5 |
| 10 | 0 | 3 | 1.7 | 16.6 | 0.0218/0.0073 | 6.0 | 6.0 | 5.8 | 24.2 |
| 11 | 0 | 2 | 1.7 | 16.6 | 0.0228/0.0076 | 6.0 | 5.4 | 5.3 | 37.0 |
| 12 | 7 | 0 | 1.7 | 13 | 0.0090/0.0030 | 7.5 | 7.3 | 7.1 | 14.4 |
| 13 | 0 | 7 | 1.7 | 13 | 0.0122/0.0041 | 7.0 | 6.7 | 6.6 | 20.8 |
| 14 | 3 | 0 | 1.7 | 13 | 0.0150/0.0050 | 6.9 | 6.7 | 6.4 | 20.0 |
| 15 | 0 | 3 | 1.7 | 13 | 0.0164/0.0055 | 6.3 | 6.0 | 5.8 | 32.8 |
| 16 | 7 | 0 | 2.3 | 16.6 | 0.0144/0.0048 | 7.5 | 7.3 | 6.9 | 15.2 |
| 17 | 0 | 7 | 2.3 | 16.6 | 0.0176/0.0059 | 7.1 | 7.0 | 6.6 | 20.7 |
| 18 | 3 | 0 | 2.3 | 16.6 | 0.0204/0.0068 | 7.1 | 7.1 | 6.7 | 14.3 |
| 19 | 0 | 3 | 2.3 | 16.6 | 0.0218/0.0073 | 6.9 | 6.3 | 5.8 | 27.7 |

### EXAMPLE 2

A sugar-free dry mix for preparing a pudding in the home by a consumer can be prepared using the artificial sweetener of this invention. Such a dry mix, for example, could be prepared by blending the following ingredients:

| Ingredients | Amount (wt. %) |
|---|---|
| Corn Starch | 26.3 |
| Medium Dutched Cocoa | 16.4 |
| Modified Corn Starch | 11.7 |
| Salt | 1.4 |
| Vanilla Flavor | 0.4 |
| Erythritol | 42.84 |
| Sucralose | 0.071 |
| Calcium Carrageenan | 0.44 |
| Polysorbate 60 | 0.3 |
| Fumaric Acid | 0.2 |

This dry formulation would be sugar free. To prepare a pudding, a consumer could mix about 70 g of this dry formulation with about 2 cups of milk (or reconstituted milk solids) and than heat on the stove top until a rolling boil is obtained. The consumer would then pour the mixture into suitable containers and refrigerate until firm.

The milk used would determine whether the pudding itself would be considered sugar free. If lactose-free milk or sugar-free milk were used to prepare the pudding, the pudding itself would be sugar free. For purposes of this invention and the attached claims, a pudding or other dessert product prepared using a sugar-free dry mix would be considered “sugar free” regardless of the milk used since the dry mix itself is sugar free.

We claim:

1. A sugar-free dessert product containing at least about 9 percent sugar equivalent sweetness, said dessert product comprising an effective amount of an artificial sweetener composition, wherein the artificial sweetener composition comprises an artificial sweetener and a sugar alcohol, wherein the relative amounts of the artificial sweetener and the sugar alcohol are balanced to significantly reduce aftertaste in the dessert product as compared to a similar dessert product prepared only with the artificial sweetener.

2. The sugar-free dessert product as in claim 1, wherein the artificial sweetener is selected from the group consisting of sucralose and a mixture of sucralose and acesulfame potassium, wherein the sugar alcohol is selected from the group consisting of sorbitol, lactitol, xylitol, mannitol, maltitol, erythritol, isomalt, hydrogenated starch hydrolysates, and mixtures thereof, and wherein the artificial sweetener provides about 20 to about 90 percent total sugar equivalent sweetness and the sugar alcohol provides about 10 to about 80 percent total sugar equivalent sweetness.

3. The sugar-free dessert product as in claim 1, wherein the artificial sweetener provides about 39 to about 67 percent total sugar equivalent sweetness and the sugar alcohol provides about 33 to about 61 percent total sugar equivalent sweetness.

4. The sugar-free dessert product as in claim 1, wherein the artificial sweetener provides about 40 to about 55 percent total sugar equivalent sweetness and the sugar alcohol provides about 45 to about 60 percent total sugar equivalent sweetness.

5. The sugar-free dessert product as in claim 2, wherein the sugar-free dessert product is a ready-to-eat pudding.

6. The sugar-free dessert product as in claim 2, wherein the sugar-free dessert product is a dry mixture from which a consumer can prepare a pudding.

7. A packaged, high temperature-processed, sugar-free, ready-to-eat pudding containing at least about 9 percent sugar equivalent sweetness, wherein the high temperature is about 265° F. or higher, prepared from a formulation comprising a fat content of less than about 3 weight percent, water, a source of soluble calcium, a thickening agent, a effective amount of an artificial sweetener composition, an emulsifier/stabilizer, and about 0.01 to about 1.5 weight percent of an ungelled, calcium-sensitive, thermally-irreversible, gelling hydrocolloid selected from the group consisting of algin and salts thereof, low methoxyl pectin, gellan gum, and combinations thereof; wherein the artificial sweetener composition comprises an artificial sweetener selected from the group consisting of sucralose and a mixture of sucralose and acesulfame potassium, and a sugar alcohol selected from the group consisting of sorbitol, lactitol, xylitol, mannitol, maltitol, erythritol, isomalt, hydrogenated starch hydrolysates, and mixtures thereof; and wherein the relative amounts of the artificial sweetener and the sugar alcohol are balanced to significantly reduce aftertaste in the pudding as compared to a similar pudding prepared only with the artificial sweetener.

8. The sugar-free, ready-to-eat pudding of claim 7, wherein the sugar alcohol is xylitol.

9. The sugar-free, ready-to-eat pudding of claim 8, wherein the artificial sweetener is mixture of sucralose and acesulfame potassium in a sugar equivalent sweetness ratio of more than about 75:25.

10. The sugar-free, ready-to-eat pudding of claim 9, wherein the sugar equivalent sweetness ratio is about 99:1 to about 75:25.

11. The sugar-free, ready-to-eat pudding of claim 9, wherein the sugar equivalent sweetness ratio is about 90:10.

12. The sugar-free, ready-to-eat pudding of claim 7, wherein the artificial sweetener composition comprises sufficient artificial sweetener to provide about 20 to about 90 percent total sugar equivalent sweetness and sufficient sugar alcohol to provide about 10 to about 80 percent total sugar equivalent sweetness.

13. The sugar-free, ready-to-eat pudding of claim 7, wherein the artificial sweetener composition comprises sufficient artificial sweetener to provide about 39 to about 67 percent total sugar equivalent sweetness and sufficient sugar alcohol to provide about 33 to about 61 percent total sugar equivalent sweetness.

14. The sugar-free, ready-to-eat pudding of claim 7, wherein the artificial sweetener provides about 40 to about 55 percent total sugar equivalent sweetness and the sugar alcohol provides about 45 to about 60 percent total sugar equivalent sweetness.

15. A method for producing a packaged, sugar-free, ready-to-eat pudding having a fat level of 0 to about 3 weight percent containing at least about 9 percent sugar equivalent sweetness, said method comprising the steps of: (1) combining and mixing water, a source of soluble calcium, starch, an artificial sweetener composition, an emulsifier/stabilizer and/or polyphosphate, and an ungelled, calcium-sensitive, thermally-irreversible, gelling hydrocolloid at a level of about 0.01 to about 1.5 weight percent, the hydrocolloid being added to an aqueous solution containing soluble calcium at a temperature of less than about 150° F. and the hydrocolloid being selected from the group consisting of algin and salts thereof, low methoxyl pectin, gellan gum, and combinations thereof; (2) homogenizing the mix; (3) heating the mixture to a temperature above about 265° F. for a sufficient period of time to sterilize the mix and cook the starch; (4) cooling the sterilized mix to a temperature below about 140° F.; and (5) packaging the cooled pudding; wherein the artificial sweetener composition comprises (I) an artificial sweetener selected from the group consisting of sucralose and a mixture of sucralose and acesulfame potassium, and (ii) a sugar alcohol selected from the group consisting of sorbitol, lactitol, xylitol, mannitol, maltitol, erythritol, isomalt, hydrogenated starch hydrolysates, and mixtures thereof; and wherein the relative amounts of the artificial sweetener and the sugar alcohol are balanced to significantly reduce aftertaste in the pudding as compared to a similar pudding prepared only with the artificial sweetener.

16. The method of claim 15, wherein the sugar alcohol is xylitol.

17. The method of claim 15, wherein the artificial sweetener is mixture of sucralose and acesulfame potassium in a sugar equivalent sweetness ratio of more than about 75:25.

18. The method of claim 17, wherein the sugar equivalent sweetness ratio is about 99:1 to about 75:25.

19. The method of claim 17, wherein the sugar equivalent sweetness ratio is about 90:10.

20. The method of claim 15, wherein the artificial sweetener composition comprises sufficient artificial sweetener to provide about 20 to about 90 percent total sugar equivalent sweetness and sufficient sugar alcohol to provide about 10 to about 80 percent total sugar equivalent sweetness.

21. The method of claim 15, wherein the artificial sweetener composition comprises sufficient artificial sweetener to provide about 39 to about 67 percent total sugar equivalent sweetness and sufficient sugar alcohol to provide about 33 to about 61 percent total sugar equivalent sweetness.

22. The method of claim 15, wherein the artificial sweetener provides about 40 to about 55 percent total sugar equivalent sweetness and the sugar alcohol provides about 45 to about 60 percent total sugar equivalent sweetness.
